(19) United States
(12) Patent Application Publication
(10) Pub. No.: US 2006/0087066 A1
(43) Pub. Date: Apr. 27, 2006

(54) Attaching and connecting element for a system for building devices for clamping workpieces

(76) Inventor: Horst Witte, Nahrendorf (DE)

Correspondence Address: Friedrich Kueffner, Suite 910, 317 Madison Avenue, New York, NY, 10017, US

(21) Appl. No.: 11/246,020

(22) Filed: Oct. 6, 2005

(30) Foreign Application Priority Data
Oct. 6, 2004 (DE) 20 2004 015 575.3

(51) Int. Cl. B23Q 3/02

(52) U.S. Cl. 269/99

(57) ABSTRACT

An attaching and coupling element for a system for building devices for clamping workpieces, which system comprises a T-groove section having T-shaped grooves extending longitudinally and vertical bores spaced apart at a grid spacing from one another in the longitudinal direction and extending vertically into the T-shaped grooves, has a holding member provided with sliding blocks on an underside of the holding member and a coupling plate having an underside with a recess for receiving the holding member. At least two of the sliding blocks are spaced at the grid spacing from one another. The holding member has passages spaced at the grid spacing from one another. The coupling plate has centering pins and at least two of the centering pins are spaced at the grid spacing from one another. The centering pins are insertable through the passages of the holding member into the vertical bores.

### BACKGROUND OF THE INVENTION

1. Field of the Invention

The invention relates to an attaching and connecting element for a system for building devices for clamping workpieces. The attaching and connecting element is a T-groove section having T-shaped grooves. Vertical bores are provided along the longitudinal axis of the T-shaped grooves and spaced at a certain grid spacing from one another. Sliding blocks can be inserted into the vertical grooves.

2. Description of the Related Art

Attaching and connecting elements for systems for building devices for clamping workpieces are known in various embodiments. They comprise attachment components or other parts to which workpiece receptacles or other profiled sections can be attached.

European patent application 04 016 159.8 discloses a system for building devices for clamping workpieces that is comprised of T-groove sections provided with vertical bores that are positioned at a spacing from one another that corresponds to a grid spacing along the longitudinal axis of the T-shaped grooves; into the vertical bores, sliding blocks can be inserted that have a cylindrical section that fits into the vertical bores spaced at the grid spacing. These sliding blocks that are arranged at the grid spacing to one another serve for attaching additional elements and attachment components.

### SUMMARY OF THE INVENTION

It is an object of the present invention to provide an attaching and connecting element for the aforementioned prior art system that enables the attachment and connection of additional sections or workpiece receptacles in an especially advantageous and reproducible way.

In accordance with the present invention, this is achieved in that at least two sliding blocks are provided, spaced at the grid spacing relative one another, on the underside of a holding member that is provided at the grid spacing with passages in the form of cutouts and/or through openings and onto which a coupling plate can be placed which has at its underside a recess for receiving the holding member and at least two centering pins that are spaced at the grid spacing from one another and are insertable through the passages in the form of cutouts and/or through openings into the vertical bores.

The attaching and connecting element according to the present invention is of a two-part configuration. It is comprised of a holding member that can be inserted by means of the monolithic sliding blocks into the T-shaped grooves of the T-groove section and can be moved therein by means of the sliding blocks so that it is positive lockingly secured in the insertion direction. Onto this holding member, the other part, i.e., the coupling plate, is placed wherein the centering pins ensure a precise positioning relative to the holding member by engagement of the cutouts and/or through openings and by snapping into place in the vertical bores. The sliding blocks provide by means of their undercuts after movement of the holding member a positive-locking securing action against being pulled out. The centering pins ensure precise positioning of the coupling plate in relation to the holding member and in particular in relation to the T-groove section. The recess at the underside of the coupling plate receives the holding member so that the coupling plate rests FLAT on the T-groove section. Fastening screws pass through the coupling plate and are received by threaded bores on the center axis of the sliding blocks. In this way, the appropriately positioned coupling plate can be secured and fixed.

Depending on which type of attaching and connecting element is desired, i.e., which attaching or connecting task is to be solved, and depending on the configuration of the T-groove section, the holding member is designed differently. However, there are always at least two sliding blocks and two centering pins. Advantageously, the sliding blocks can also be arranged in the shape of a regular rectangle and, in this way, provide for a correspondingly safe and groove-overlapping attachment. The coupling plate is then designed correspondingly.

The attaching and connecting element serves not only for connecting attachment elements to one another that are more or less of a parallelepipedal shape but these attaching and connecting elements are also suitable for realizing a connection to base plates or machine tables that are provided with such T-shaped grooves.

In a preferred embodiment, the centering pins are fitting pins that fit into the vertical bores embodied as fitting bores on the T-shaped grooves.

The T-shaped grooves are spaced from one another at the grid spacing, or at a portion of the grid spacing, or at a multiple of the grid spacing, wherein the centering pins are spaced accordingly.

In another embodiment, at least four sliding blocks spaced at the grid spacing, a portion of the grid spacing or a multiple of the grid spacing relative to one another form a regular rectangle.

In another embodiment, attachment members for attaching additional elements are provided on the topside of the attaching and connecting element.

### BRIEF DESCRIPTION OF THE DRAWING

In the drawing:

FIG. 1 shows an exploded perspective view of one embodiment of an attaching and connecting element according to the present invention before being mounted on a T-groove section;

FIG. 2 shows a perspective illustration in accordance with FIG. 1 after completion of a first stage of assembly, i.e., after insertion of the holding member;

FIG. 3 shows a perspective illustration in accordance with FIG. 1 after the holding member has been moved in the longitudinal direction of the T-shaped groove for positive-lockingly securing the holding member;

FIG. 4 shows a perspective illustration in accordance with FIGS. 1 to 3 from below before placing the coupling plate thereon;

FIG. 5 shows a perspective illustration in accordance with FIGS. 1 to 4 after placement of the coupling plate;

FIG. 6 is a perspective illustration in accordance with FIG. 5 after tightening the screws for securing the coupling plate;

FIG. 7 is an exploded perspective view in accordance with FIG. 1 showing another embodiment of the holding member and the coupling plate;

FIG. 8 is a perspective view similar to FIG. 1 of yet another embodiment;

FIG. 9 is a perspective illustration similar to FIG. 1 but showing two adjacently positioned T-groove sections, connected by means of a correspondingly designed attaching and connecting element;

FIG. 10 is a view corresponding to FIG. 4 but of the embodiment according to FIG. 9;

FIG. 11 is a perspective illustration similar to FIG. 4 but of the embodiment according to FIG. 8; and

FIG. 12 is a perspective view of an embodiment for building a hollow section of several rectangular T-groove sections.

### DESCRIPTION OF THE PREFERRED EMBODIMENTS

FIGS. 1 to 6 show a T-groove section 1 that is designed in accordance with the disclosure of the aforementioned European patent application 04 016 159.8. This T-groove section 1 has parallel T-shaped grooves 2 which are positioned at a grid spacing A relative to one another. Vertical bores 3 are provided in these T-shaped grooves 2. They are preferably designed as fitting bores and are also positioned at a grid spacing A relative to one another. Toward the end of the T-groove section the fitting bores 3 have a spacing A/2 of half the grid spacing A relative to the end. The section 1 has a width of 2A and a height A so that it can be assembled with other sections 1 by maintaining the grid spacing or a multiple of the grid spacing.

The attaching and connecting element is comprised of two parts, i.e., a holding member 4 and a coupling plate 10.

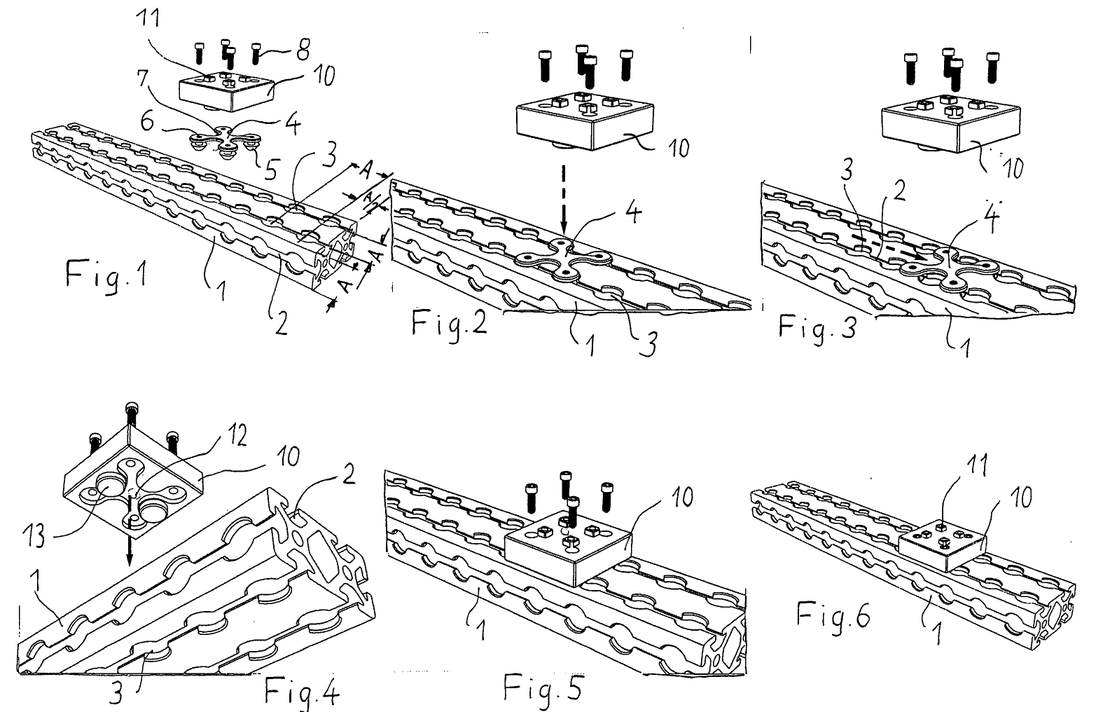

In the embodiment according to FIGS. 1 through 6, the holding member 4 has on its underside four sliding blocks 5 that are spaced at the aforementioned grid spacing A to one another and can be inserted into the vertical bores 3. The undercuts, i.e., the sections of greater diameter at the lower end of the sliding blocks 5, can be moved within the T-shaped grooves so that the holding members are then secured against being pulled out. This process is illustrated in FIG. 2 (insertion) and FIG. 3 (displacement). The holding member 4 is star-shaped, i.e., it has passages in the form of cutouts 7 that are approximately semi-circular. Threaded fasetning bores 6 serve for receiving the fastening screws 8.

The coupling plate 10 is provided at its underside with a recess 12 that is predetermined by the shape of the holding member 4 and is designed for receiving the holding member 4; this is apparent when viewing FIG. 4. Moreover, two centering pins 13 are provided that are spaced at the grid spacing and have a diameter that matches that of the vertical bores so that the centering pins fit in the vertical bores. The coupling plate 10 is then placed onto the inserted and moved holding member 4 wherein the holding member 4 disappears in the recess 12 and the centering pins 13 are guided through the cutouts 7 and inserted into the selected vertical bores 3. The final fixation and attachment is then realized by means of the fastening screws 8 that are threaded into the threaded fastening bores 6. The attaching and connecting element then is in a position precisely defined by the grid spacing. Receiving member 11 serves for arranging additional sections or for attaching workpiece receptacles.

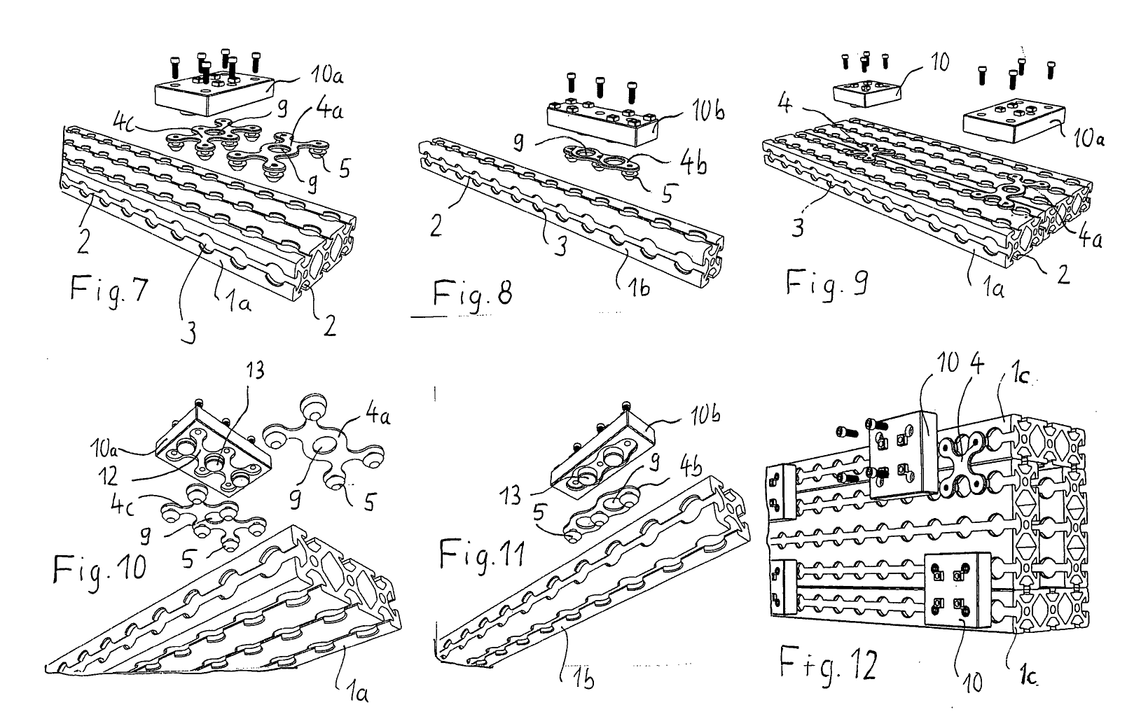

In FIGS. 7 through 10, another embodiment of a holding member 4a and 4c is illustrated in connection with a matching differently designed coupling plate 10a. The holding members 4a and 4c have four (embodiment 4a) or 6 (embodiment 4c) sliding blocks that are correspondingly spaced apart so that they can be received in the vertical bores 3 of the T-groove section 1a and can be laterally moved within the corresponding T-shaped grooves. An appropriately designed coupling plate 10a with a recess 12 at the underside and with three centering pins 13 is then placed in the afore described way onto the holding member 4a or 4c and secured by means of the fastening screws. Instead of the cutouts 7, the center has a passage in the form of a through opening 9.

The embodiment according to FIGS. 8 and 11 shows a simple T-groove section with square cross-section in which an elongate attaching and connecting element can be mounted. The holding member 4b has three sliding blocks 5 and two through openings 9 as passages. Accordingly, the coupling plate 10b is provided with two centering pins 13.

FIG. 9 shows a possibility of assembling two groove sections 1a to a wide plate by means of attaching and connecting elements 10 and 10a.

Another possibility is shown in FIG. 12. A hollow rectangular section comprised of T-groove sections 1c is assembled with the aid of holding members 4 and coupling plates 10. These coupling plates 10 also serve for attaching additional parts.

In the embodiments according to FIGS. 1 through 3, four fastening screws 8 and matching through holes or threaded bores 6 are shown. It is in principle also conceivable to provide only a central fastening screw that is then inserted through a central opening in the coupling plate and ends in a thread at the center of the holding member 4. This embodiment with a screw is essentially suitable in order to attach an attaching and connecting element for mounting additional parts on a single section. When two parts are to be connected with one another, the embodiment with at least two fastening screws is advantageous.

It is apparent that the connecting and attaching element can be designed in very different ways. The holding member 4 has the sliding blocks 5 that are to be inserted into the vertical bores 3 and, after displacement, provide a corresponding securing action against being pulled out. The centering pins 13 serve for providing a precise arrangement within the grid pattern. The fastening screws 8 serve for providing a final fixation and securing action.

While specific embodiments of the invention have been shown and described in detail to illustrate the inventive principles, it will be understood that the invention may be embodied otherwise without departing from such principles.

What is claimed is:

1. An attaching and coupling element for a system for building devices for clamping workpieces, wherein the system comprises a T-groove section having T-shaped grooves extending in a longitudinal direction of the T-groove section, wherein the T-groove section has vertical bores spaced apart at a grid spacing from one another in the longitudinal direction and extending vertically into the T-shaped grooves; the attaching and coupling element comprising:
a holding member provided with sliding blocks on an underside of the holding member, wherein at least two of the sliding blocks are spaced at the grid spacing from one another;
the holding member having passages spaced at the grid spacing from one another;
a coupling plate having an underside with a recess for receiving the holding member;
the coupling plate having centering pins, wherein at least two of the centering pins are spaced at the grid spacing from one another;
wherein the centering pins are insertable through the passages of the holding member into the vertical bores of the T-groove section.

2. The attaching and connecting element according to claim 1, wherein the passages are cutouts or through openings.

3. The attaching and connecting element according to claim 1, wherein the centering pins are fitting pins that fit into the vertical bores embodied as fitting bores.

4. The attaching and connecting element according to claim 1, wherein the T-shaped grooves have a spacing relative to one another that matches the grid spacing or a portion of the grid spacing or a multiple of the grid spacing, wherein a spacing of the centering pins relative to one another match the spacing of the T-shaped grooves.

5. The attaching and connecting element according to claim 1, wherein at least four of the sliding blocks are positioned at a spacing relative to one another that matches the grid spacing or a portion of the grid spacing or a multiple of the grid spacing, wherein the at least four sliding blocks define a regular rectangle.

6. The attaching and connecting element according to claim 1, wherein attachment members for attachment of additional elements are provided on a topside of the attaching and connecting element.
